(19) United States
(12) Patent Application Publication
(10) Pub. No.: US 2017/0305100 A1
(43) Pub. Date: Oct. 26, 2017

(54) DECORATIVE SUBSTRATES HAVING ADHESIVE LAYERS

(71) Applicants: Chee K. Tan, Atlanta, GA (US); Yannie K. Tan, Atlanta, GA (US)

(72) Inventors: Chee K. Tan, Atlanta, GA (US); Yannie K. Tan, Atlanta, GA (US)

(21) Appl. No.: 15/482,374

(22) Filed: Apr. 7, 2017

Related U.S. Application Data
(60) Provisional application No. 62/319,570, filed on Apr. 7, 2016.

(51) Int. Cl. B32B 3/26; B32B 7/12; B32B 37/12

(52) U.S. Cl. CPC B32B 3/26; B32B 37/12; B32B 7/12; B32B 2451/00

(57) ABSTRACT

Disclosed herein is a kit including one or more decorative elements (pixel layers) and a substrate. The pixel layers can comprise a pre-shaped layer of rigid, semi-rigid, and/or flexible material that can mate with and/or attach to a substrate (for example, to decorate the substrate). Moreover, the substrate can have an adhesive backing to attach to at least one surface. Example uses of the disclosure include toy building blocks and hobby craft kits (for example, hobby craft kits including creative patterns with instructions, pixel layers, and substrates). The hobby craft kits can be used to make abstract designs for decorating notebook covers, phone covers, and tablet covers.

### RELATED APPLICATION

This application claims priority to U.S. Provisional Application Ser. No. 62/319,570, titled “Decorative Substrates Having Adhesive Layers,” filed Apr. 7, 2016, the contents of which are incorporated herein by reference.

### TECHNICAL FIELD

This disclosure generally relates to construction kits including substrates that can be decorated with various decorative elements and can be removably attached to various mediums.

### BACKGROUND

Construction kits can refer to sets of physical pieces that allow for the construction of a variety of different models, including decorative elements. The kits can avoid the lead time of manufacturing custom pieces, and of requiring special training or design time to construct the models. Construction kits can be used for temporary structures, or for use as children's toys.

### BRIEF DESCRIPTION

Embodiments of the disclosure can include substrates that can be decorated with various decorative elements and can be removably attached to various mediums. In one embodiment, an apparatus can include a pixel layer, and a substrate, the substrate including a flexible and separable unit. The substrate can include one or more protrusions and the pixel layer comprises one or more cavities. The pixel layer can be attached to the substrate at least in part by a mechanical mating of the one or more cavities of the pixel layer with the one or more protrusions of the substrate. The substrate further includes an adhesive layer on at least one face of the substrate.

In one aspect of an embodiment, the adhesive layer can further include a washable layer.

In one aspect of an embodiment, the adhesive layer can further include one or more of a synthetic adhesive, a pressure-sensitive adhesive (PSA), a multi-component adhesive, a contact adhesive, a solvent-based adhesive, or a polymer dispersion adhesive.

In one aspect of an embodiment, the substrate can further include one or more perforations to facilitate the separability of the substrate into one or more smaller constituent substrates.

In one aspect of an embodiment, the adhesive layer can further include a removable backing layer that at least partially protects the adhesive layer from at least one environmental factor.

In one aspect of an embodiment, the removable backing layer can include a plastic film.

In one aspect of an embodiment, the adhesive layer adheres to a surface of a predetermined type.

In one aspect of an embodiment, the pixel layer can further include an adhesive layer.

In one aspect of an embodiment, the adhesive layer can further include a washable layer.

In one aspect of an embodiment, the adhesive layer can further include one or more of a synthetic adhesive, a pressure-sensitive adhesive (PSA), a multi-component adhesive, a contact adhesive, a solvent-based adhesive, or a polymer dispersion adhesive.

In another embodiment, a method for decorating a surface can be provided. The method can include attaching a pixel layer to a substrate at least in part by a mechanical mating of one or more cavities of the pixel layer with one or more protrusions of the substrate, wherein the substrate has an adhesive layer on at least one face of the substrate; and attaching, using the adhesive layer, the substrate having the pixel layer to a first surface.

In one aspect of an embodiment, the substrate and/or pixel layer can further include a flexible and separable unit.

In one aspect of an embodiment, the adhesive layer can further include a washable layer.

In one aspect of an embodiment, the adhesive layer can further include one or more of a synthetic adhesive, a pressure-sensitive adhesive (PSA), a multi-component adhesive, a contact adhesive, a solvent-based adhesive, or a polymer dispersion adhesive.

In one aspect of an embodiment, the substrate can further include one or more perforations to facilitate the separability of the substrate into one or more smaller constituent substrates.

In one aspect of an embodiment, the adhesive layer can further include a removable backing layer that at least partially protects the adhesive layer from at least one environmental factor.

In one aspect of an embodiment, the removable backing layer can further include a plastic film.

In one aspect of an embodiment, the method can further include adhering the adhesive layer to a surface of a predetermined type.

In one aspect of an embodiment, the pixel layer can further include an adhesive layer, and the adhesive layer further comprises a washable layer.

In one aspect of an embodiment, the adhesive layer can further include one or more of a synthetic adhesive, a pressure-sensitive adhesive (PSA), a multi-component adhesive, a contact adhesive, a solvent-based adhesive, or a polymer dispersion adhesive.

In yet another embodiment, a method for decorating a surface can be provided. The method can include providing a substrate to mount a pixel layer at least in part by a mechanical mating of one or more cavities of the pixel layer with one or more protrusions of the substrate, wherein the substrate has an adhesive layer on at least one face of the substrate; and attaching, using the adhesive layer, the substrate having the pixel layer to a first surface.

In one aspect of an embodiment, the substrate and/or pixel layer can further include a flexible and separable unit.

In one aspect of an embodiment, the adhesive layer can further include a washable layer.

In one aspect of an embodiment, the adhesive layer can further include one or more of a synthetic adhesive, a pressure-sensitive adhesive (PSA), a multi-component adhesive, a contact adhesive, a solvent-based adhesive, or a polymer dispersion adhesive.

In one aspect of an embodiment, the substrate can further include one or more perforations to facilitate the separability of the substrate into one or more smaller constituent substrates.

In one aspect of an embodiment, the adhesive layer can further include a removable backing layer that at least partially protects the adhesive layer from at least one environmental factor.

In one aspect of an embodiment, the removable backing layer can further include a plastic film.

In one aspect of an embodiment, the method can further include adhering the adhesive layer to a surface of a predetermined type.

In one aspect of an embodiment, the pixel layer can further include an adhesive layer, and the adhesive layer further comprises a washable layer.

In one aspect of an embodiment, the adhesive layer can further include one or more of a synthetic adhesive, a pressure-sensitive adhesive (PSA), a multi-component adhesive, a contact adhesive, a solvent-based adhesive, or a polymer dispersion adhesive.

Other embodiments and aspects of the disclosure will become apparent from the following description taken in conjunction with the following drawings.

The following embodiments are described in sufficient detail to enable at least those skilled in the art to understand and use the disclosure. It is to be understood that other embodiments would be evident based on the present disclosure and that process, mechanical, materials, dimensional, process equipment, and parametric changes may be made without departing from the scope of the present disclosure.

In the following description, numerous specific details are given to provide a thorough understanding of various embodiments of the disclosure. However, it will be apparent that the disclosure may be practiced without these specific details. In order to avoid obscuring the present disclosure, some well-known system configurations and process steps may not be disclosed in full detail. Likewise, the drawings showing embodiments of the disclosure are semi-diagrammatic and not to scale and, particularly, some of the dimensions are for the clarity of presentation and may be exaggerated in the drawings. In addition, where multiple embodiments are disclosed and described as having some features in common for clarity and ease of illustration, description, and comprehension thereof, similar and like features will ordinarily be described with like reference numerals even if the features are not identical.

### BRIEF DESCRIPTION OF THE FIGURES

Reference will now be made to the accompanying drawings, which are not necessarily drawn to scale, and wherein:

FIG. 1 depicts a perspective view of an example kit including pixel layers, a substrate, and an adhesive layer, in accordance with example embodiments of the disclosure.

FIG. 2 illustrates an upper perspective view of an example puzzle kit with pieces including respective pixel layers, substrates, and adhesive layers, in accordance with example embodiments of the disclosure.

FIG. 3 illustrates an upper perspective view of an example piece of the puzzle kit shown in FIG. 2, in accordance with example embodiments of the disclosure.

FIG. 4 illustrates a lower perspective view of an example piece of the puzzle kit shown in FIG. 2, in accordance with example embodiments of the disclosure.

FIG. 5 illustrates an upper perspective view of an example configuration for various pieces for a puzzle kit including respective pixel layers, substrates, and adhesive layers, in accordance with example embodiments of the disclosure.

FIG. 6 illustrates an example drinking bottle, in accordance with example embodiments of the disclosure.

FIG. 7 illustrates an example drinking bottle, in accordance with example embodiments of the disclosure.

FIG. 8 illustrates an example drinking cup, in accordance with example embodiments of the disclosure.

FIG. 9 illustrates an example printing stamp, in accordance with example embodiments of the disclosure.

FIG. 10 illustrates another example printing stamp, in accordance with example embodiments of the disclosure.

FIG. 11 illustrates an example roller printing stamp, in accordance with example embodiments of the disclosure.

FIG. 12 illustrates an example patch for a bag, in accordance with example embodiments of the disclosure.

FIG. 13 illustrates an example patch for a hat, in accordance with example embodiments of the disclosure.

FIG. 14 illustrates an example patch for a jacket in accordance with example embodiments of the disclosure.

FIG. 15 illustrates an example converter device in accordance with example embodiments of the disclosure.

Embodiments of the disclosure are described more fully hereinafter with reference to the accompanying drawings, in which example embodiments of the disclosure are shown. This disclosure may, however, be embodied in many different forms and should not be construed as limited to the example embodiments set forth herein; rather, these embodiments are provided so that this disclosure will be thorough and complete, and will fully convey the scope of the disclosure to those skilled in the art. Like numbers refer to like, but not necessarily the same or identical, elements throughout. It should be understood that certain words and terms are used herein solely for convenience and such words and terms should be interpreted as referring to various objects and actions that are generally understood in various forms and equivalencies by persons of ordinary skill in the art. Furthermore, the word “example” as used herein is intended to be non-exclusionary and non-limiting in nature. More particularly, the word “exemplary” as used herein indicates one among several examples, and it should be understood that no undue emphasis or preference is being directed to the particular example being described.

### DETAILED DESCRIPTION

Embodiments of the disclosure can include substrates that can be decorated with various decorative elements and can be removably attached to various mediums. In certain embodiments of the disclosure, various substrates with or without an adhesive layer on a lower surface or underside can be used to adorn or otherwise decorate an object. A pixel layer with or without an adhesive layer on a lower surface or underside can be used to adorn or otherwise decorate an upper surface of the respective substrate. Each pixel layer includes a cavity on a lower portion of the pixel layer that can mechanically mate or otherwise mount to a protrusion or shape on an upper portion of a respective substrate. In some instances, an upper surface of the pixel layer can include a design, color, texture, and/or pattern. In some instances, the substrate and/or the pixel layer can include one or more perforations to facilitate separation of the respective substrate and/or pixel layer by cutting, manually pulling the substrate and/or pixel layer apart in relatively smaller portions, or by other separation means. In any instance, providing the substrate with or without an adhesive layer and/or providing the pixel layer with or without an adhesive layer can facilitate certain embodiments of the disclosure.

In one embodiment of the disclosure, an apparatus can include a pixel layer, and a substrate, the substrate including a flexible and separable unit. The substrate can include one or more protrusions and the pixel layer comprises one or more cavities. The pixel layer can be attached to the substrate at least in part by a mechanical mating of the one or more cavities of the pixel layer with the one or more protrusions of the substrate. The substrate further includes an adhesive layer on at least one face of the substrate.

In another embodiment of the disclosure, a method for decorating a surface can be provided. The method can include attaching a pixel layer to a substrate at least in part by a mechanical mating of one or more cavities of the pixel layer with one or more protrusions of the substrate, wherein the substrate has an adhesive layer on at least one face of the substrate; and attaching, using the adhesive layer, the substrate having the pixel layer to a first surface.

In yet another embodiment of the disclosure, a method for decorating a surface can be provided. The method can include providing a substrate to mount a pixel layer at least in part by a mechanical mating of one or more cavities of the pixel layer with one or more protrusions of the substrate, wherein the substrate has an adhesive layer on at least one face of the substrate; and attaching, using the adhesive layer, the substrate having the pixel layer to a first surface.

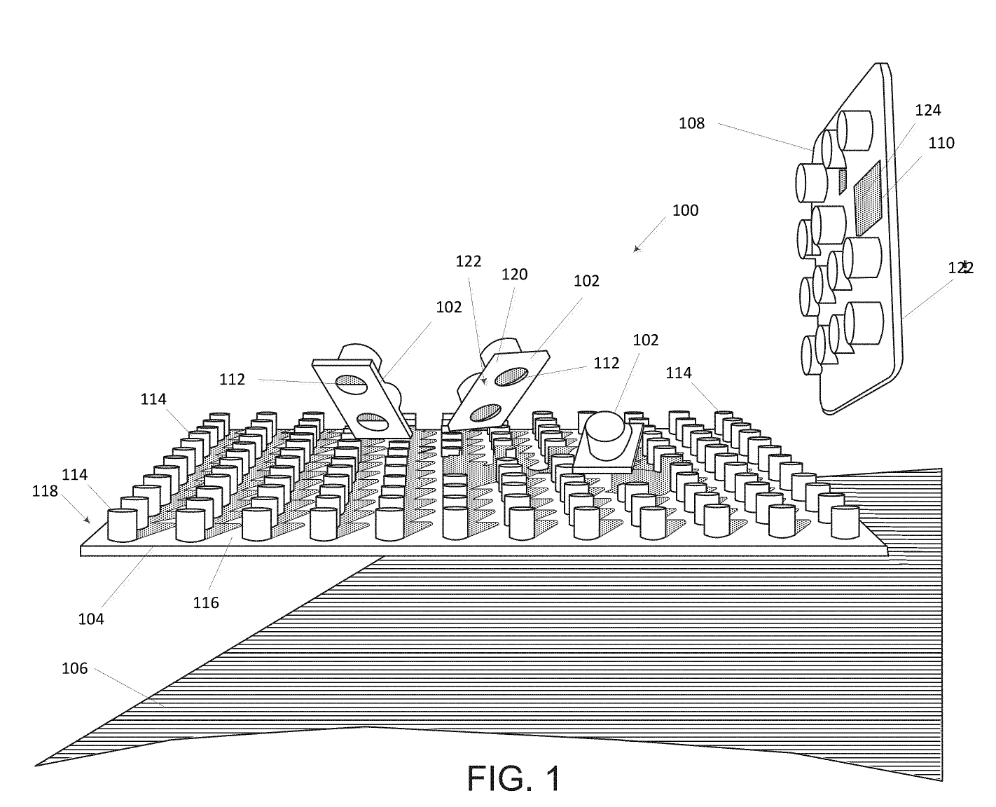

FIG. 1 depicts a perspective view of an example kit 100 including one or more decorative elements, referred to herein as pixel layers 102, a substrate 104, and an adhesive layer 106, in accordance with example embodiments of the disclosure. The pixel layers 102 can include a pre-shaped layer of rigid, semi-rigid, and/or flexible material that can mate with, connect, and/or attach to a substrate 104, for example, to decorate the substrate 104. Moreover, the substrate 104 can optionally have an adhesive 106 or adhesive backing to attach to at least one surface. Example uses of the disclosure include toy building blocks, and hobby craft kits including creative patterns with instructions, square pixel pieces, and substrates for making abstract designs, roller dot stamp makers, luggage tags, stickers, pencil cases, gift boxes, decorated mugs, decorated water bottles, decorated tumblers, decorated purses, decorated wallets, custom greeting cards, decorations for tote bags, decorated picture frames, decorations for hats and shoes, decorations for arm, wrist and head bands, decorations for pillows, decorated notebook covers, decorated phone covers and decorated tablet covers.

The term “horizontal” as used herein may be defined as a direction parallel to a plane or surface (e.g., surface of a substrate), regardless of its orientation. The term “vertical” as used herein may refer to a direction orthogonal to the horizontal direction as just described. Terms, such as “on,” “above,” “below,” “bottom,” “top,” “side” (as in “sidewall”), “higher,” “lower,” “upper,” “over,” and “under,” may be referenced with respect to the horizontal plane. Also, the terms “face” and “surface” may be used interchangeably, and can refer to an upper portion, lower portion, lateral portion, or any other exposed exterior plane of a referenced object.

In one embodiment, a pixel layer, such as 108, can be formed from sheets of a predetermined material (for example, rubber, plastic, and the like), which can be singulated and/or partially singulated into one or more different shapes in one or more different sizes. One will recognize that the shapes and sizes can be any number of configurations including, but not limited to, squares, strips, rectangles, triangular-shapes, geometric shapes, polygonal shapes, etc. In one embodiment, the pixel layer 102, 108 and/or the substrate 104 can be stretchable and/or separable. For example, the pixel layer 102, 108 and/or the substrate 104 can include a material that is stretchable such as rubber, or a plastic. Other example substrates can include, but are not limited to, magnetic sheets, cardboard stock, plastic, acrylic, wood, metal sheets, Eva foam, etc. Depending on the mechanical strength and properties of the selected material, this can allow the pixel layer 102, 108 and/or the substrate 104 to be pulled apart (for example, manually pulled apart) as needed, but the material is not required to be separable. Alternatively, the pixel layer 102, 108 and/or the substrate 104 can be cut into a predetermined shape by a scissor or a blade, but the material is not required to be separable in this manner. Moreover, the pixel layer 102, 108 and/or the substrate 104 can include perforations 110 to facilitate the separability of a relatively larger pixel layer and/or substrate into one or more relatively smaller constituent pixel layers and/or substrates, but the materials are not required to include perforations. The pixel layer 102, 108 can include indentations and/or cavities 112 that can fit into one or more protrusions 114 of the substrate 104 to allow for attaching the pixel layer 102, 108 to the substrate 104.

In one embodiment, the substrate 104 can include a pre-shaped layer of rigid, semi-rigid, and/or flexible material that can mate with and/or attach to one or more pixel layers. One will recognize that the shapes and sizes of the substrate 104 can be any number of configurations including, but not limited to, squares, strips, rectangles, circles, ovals, triangular-shapes, geometric shapes, polygonal shapes, etc. In one embodiment, the substrate 104 can include an adhesive layer 116 on at least one face 118 of the substrate 104. In one embodiment, the pixel layers 102, 108 can include an adhesive layer 120 on at least one face 122 of the respective pixel layer 102, 108, for example, to allow for adhesion between the pixel layer 102, 108 and the respective substrate 104. Thus, one will recognize that in certain embodiments, the adhesive layer 116, 120 can substantially extend or otherwise cover a surface or face of a respective pixel layer 102, 108 and/or substrate 104. Thus, rather than adhesive covering a relatively small portion of the surface, such as a dot of adhesive, the adhesive can cover the respective surface or face not otherwise occupied by a protrusion and/or cavity. In one embodiment, the adhesive layer 116, 120 can include a washable adhesive layer. For example, the adhesive layer 116, 120 can be wiped down and/or washed with soap, various cleaning fluids and/or cleaning agents, and/or water to remove debris, dirt, other environmental factors, and the like and/or to sanitize the adhesive layer 116, 120. In various aspects, the adhesion properties of the adhesive layer 116, 120 may not be substantially diminished by wiping and/or washing the adhesive layer because the adhesive material including the adhesive layer 116, 120 does not substantially chemically interact with soap, various cleaning fluids and/or cleaning agents, and/or water.

In one embodiment, the adhesive layer 116, 120 can include a removable backing layer 124 that at least partially protects the adhesive layer 116, 120 from the environment (for example, from water vapor and natural oils from the skin of the human body). The removable backing layer 124 can include a plastic film. The plastic film can include, but not be limited to, polyethylene, low-density polyethylene, medium-density polyethylene, high-density polyethylene, and linear low-density polyethylene, polypropylene, polypropylene cast film, biaxially oriented polypropylene film (BOPP), uniaxially oriented polypropylene, polyester, biaxially oriented polyester, and/or nylon polyvinyl chloride. In one embodiment, the removable backing layer can include a bioplastic and/or a biodegradable plastic film. In another embodiment, the removable backing layer 124 can include a semiembossed film. The semiembossed film can include a calendared rubber to retain the properties of rubber and also to reduce dust and other foreign matters from sticking to the rubber while calendaring and during storage. In another embodiment, the adhesive layer 116, 120 does not have a plastic backing.

In certain embodiments of the disclosure, the adhesive layer 116, 120 can adhere to a surface of a predetermined type. For example, the adhesive layer 116, 120 can adhere to one or more of a glass surface, a surface associated with a door, a surface associated with a wall, a surface of a laptop, a surface of a cellphone, a surface of a tablet, and the like. In one embodiment, the adhesive layer 116, 120 can adhere to a surface of a predetermined number of surface types, while not adhering to surfaces of the other type. In another embodiment, the adhesive layer 116, 120 for the pixel layers 102, 108 can allow for adhesion between the pixel layers 102, 108 and the respective substrate 104. In one embodiment, the adhesive layer 116, 120 for the pixel layers 102, 108 does not necessarily allow for adhesion between the pixel layers 116, 120 and other kinds of surfaces (for example, a glass surface, a surface associated with a door, a surface associated with a wall, a surface of a laptop, a surface of a cellphone, a surface of a tablet, and the like).

In one embodiment, the indentations and/or cavities 112 of the pixel layer 102, 108 and/or the one or more protrusions 114 of the substrate 104 can have a cylindrical shape. In another embodiment, the indentations and/or cavities 112 of the pixel layer 102, 108 and/or the one or more protrusions 114 of the substrate 104 can have a tubular shape, having a cylindrical cavity therein. In other embodiments of the disclosure, the indentations and/or cavities 112 of the pixel layer 102, 108 and/or the one or more protrusions 114 of the substrate 104 can be cross-shaped, or they may have any other symmetrical or non-symmetrical cross section.

In one embodiment, the pixel layers 102, 108 can be separated into individual units that are approximately 2 cm×approximately 2 cm, approximately 3 cm×approximately 3 cm, approximately 4 cm×approximately 4 cm, etc., in dimensions. In another embodiment, the individual units can be N cm×M cm, where N and M represent any real number, and N and M are not necessarily the same number. In other embodiments, the units can be N units×M units, where the units represent any unit system (pixels, cm, inch, mm, and the like).

In one embodiment, the substrate 104 can include at least a portion of a bookcase, a luggage tag, an art board, a phone case, a laptop case, a tablet case, and the like. In another embodiment, the substrate 104 can be attached to a surface with the adhesive layer 106.

In one embodiment, the substrate 104 and/or the pixel layer 102, 108 can have a shape that is substantially rectangular. In another embodiment, the substrate 104 and/or the pixel layer 102, 108 can have a shape that is substantially non-rectangular (for example, triangular, trapezoidal, circular, pentagonal, hexagonal, arched, and the like). In example embodiments, the substrate 104 and/or the pixel layer 102, 108 may be fabricated of any suitable material, including polymer material, ceramic material, plastics, composite materials, glass, epoxy laminates of fiberglass sheets, FR-4 materials, FR-5 materials, combinations thereof, or the like. In other aspects, the substrate 104 and/or the pixel layer 102, 108 can be made partially or fully from a molding compound which may be any suitable molding material. For example, the molding compound may be a liquid dispensed thermosetting epoxy resin molding compound.

In various embodiments, the adhesive layer 106 can include a drying adhesive, including a solvent-based adhesive and/or a polymer dispersion adhesive (which may also be referred to as an emulsion adhesive). Depending on the chemical composition of the adhesive including the adhesive layer 106, the adhesive layer 106 can adhere to different materials to greater or lesser degrees.

In one embodiment, the adhesive layer 106 can include a pressure-sensitive adhesive (PSA). The PSA of the adhesive layer 106 can be soft enough to flow (i.e., “wet” to the adherend (the surface to which an adhesive layer adheres). The PSA can be manufactured with either a liquid carrier or in solid form. The adhesive layer 106 can be at least partially made from liquid PSAs by coating the adhesive on one face of the substrate and drying off the solvent or water carrier. The PSA may be further heated to initiate a cross-linking reaction and increased molecular weight. Solid PSAs may be low viscosity polymers that are coated and then reacted with radiation to increase molecular weight and form the adhesive, or they may be high viscosity materials that can be heated to reduce viscosity enough to allow coating, and then cooled to their final form. In various embodiments, the PSA can include an acrylate-based polymer.

In one embodiment, the adhesive layer 106 can include a contact adhesive. The contact adhesive can include natural rubber and/or polychloroprene (neoprene). In one embodiment, the contact adhesive may be applied to both the substrate and the adherend surface, and may need to be given some time to dry before the substrate and the adherend surface are contacted.

In one embodiment, the adhesive layer 106 can include multi-component adhesives. The multi-component adhesives can harden by mixing two or more components which chemically react. This reaction can cause polymers to cross-link into acrylics, urethanes, and/or epoxies.

Various combinations of multi-component adhesives can be used. Some of these combinations can include polyester resins/polyurethane resins; polyols/polyurethane resin; and/or acrylic polymers/polyurethane resins. In one embodiment, the adhesive layer 106 can include synthetic adhesives. The synthetic adhesives can be based on elastomers, thermoplastics, emulsions, and thermosets. The thermosetting adhesive can include epoxy, polyurethane, cyanoacrylate, and acrylic polymers.

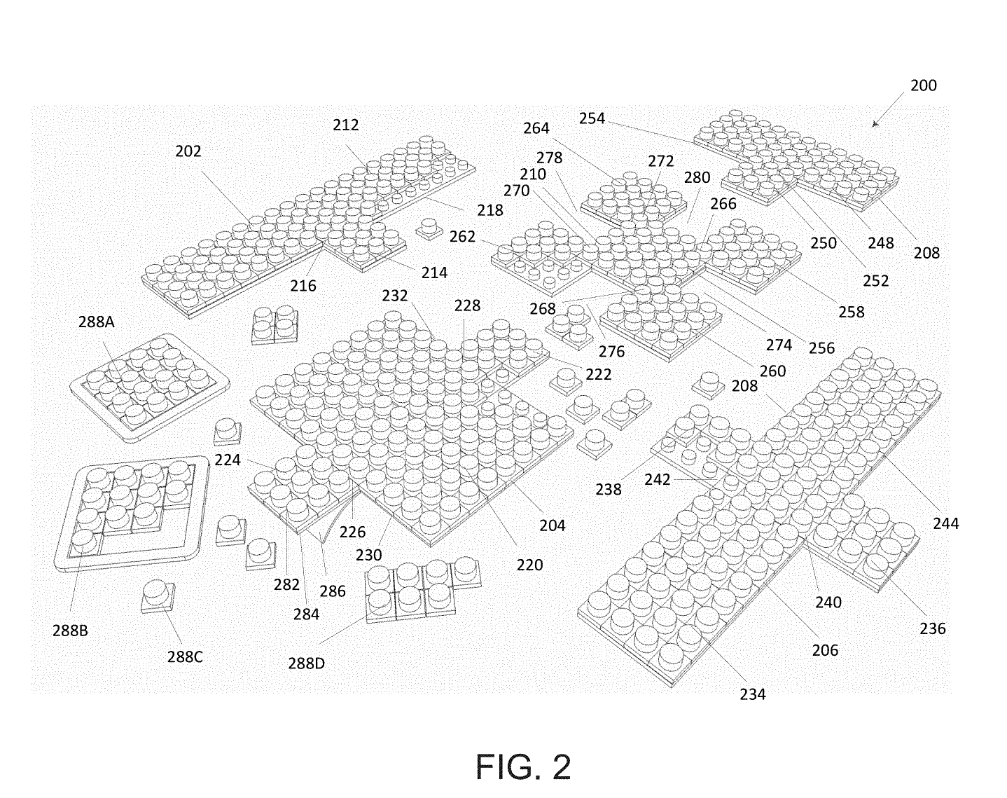

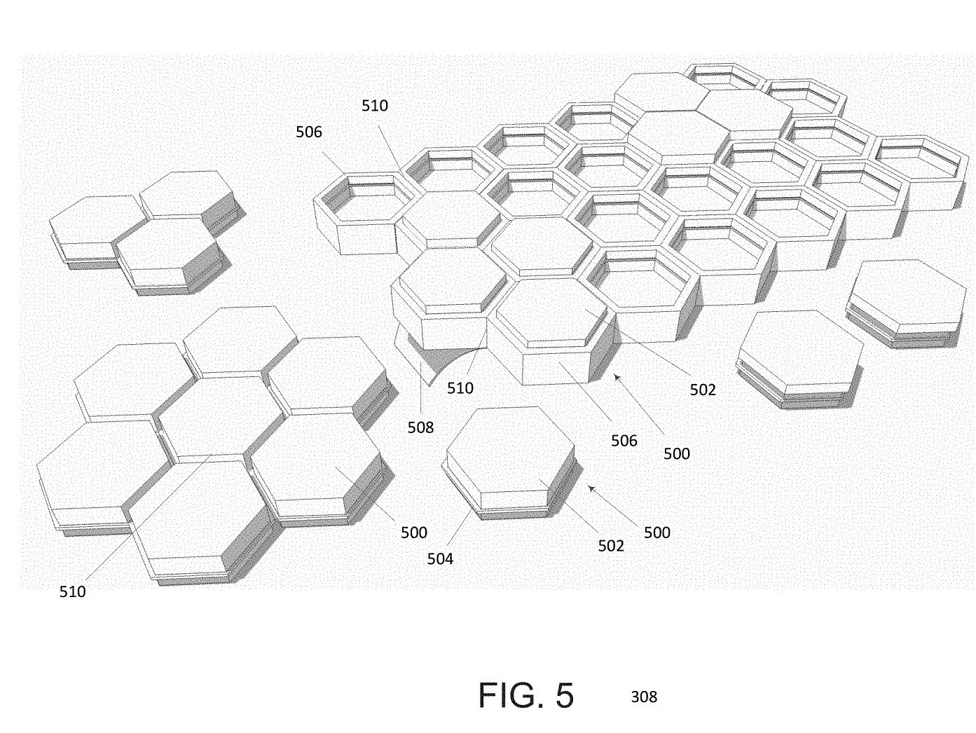

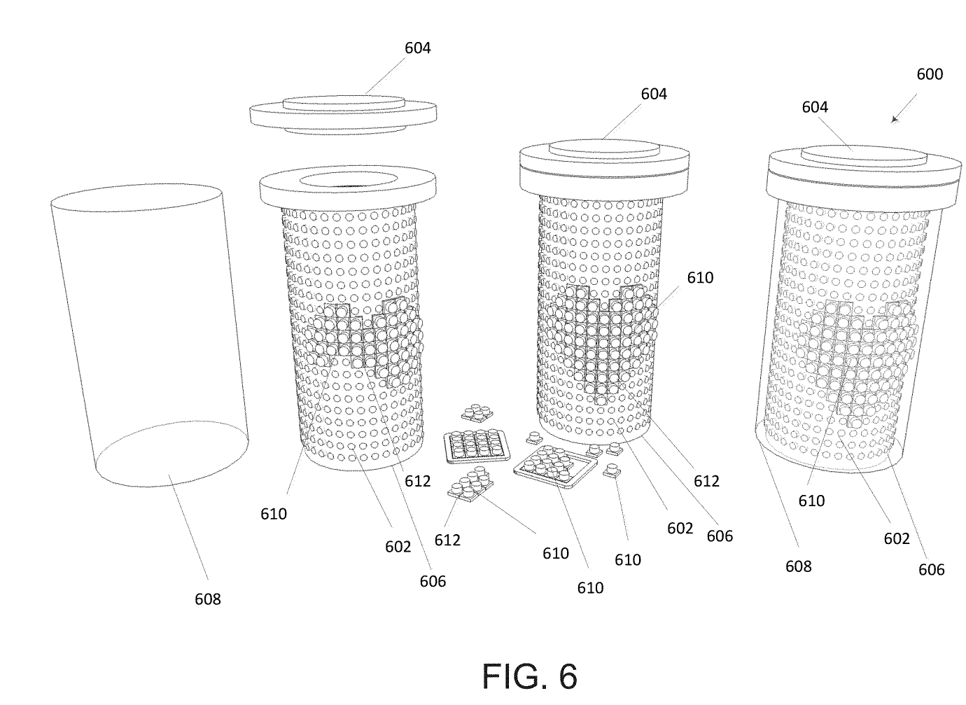

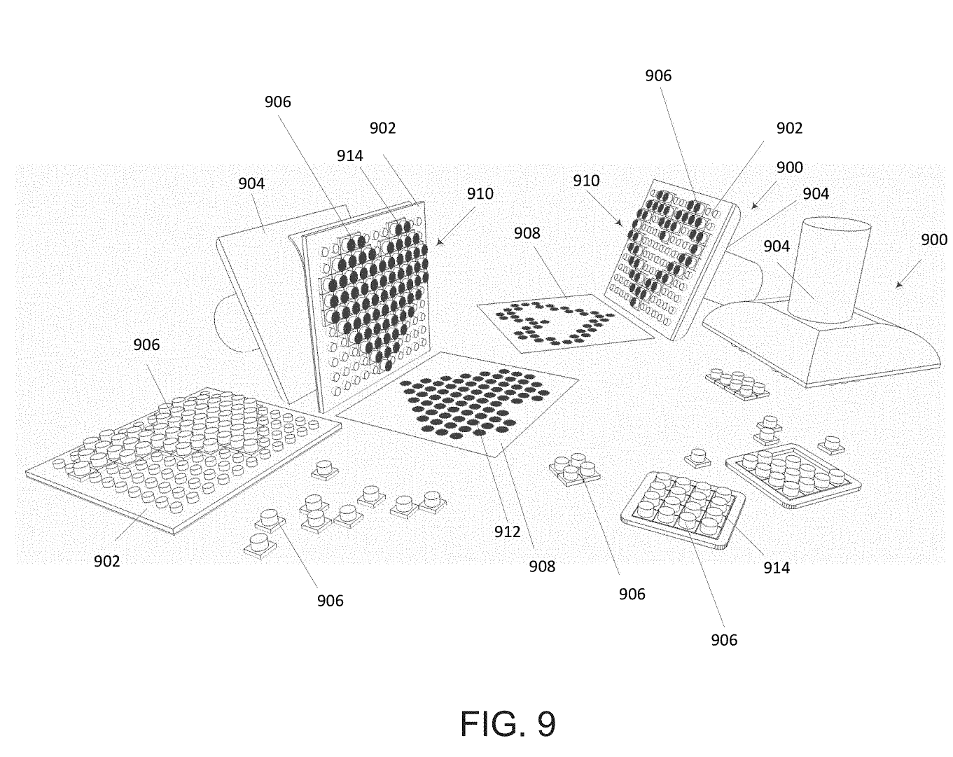

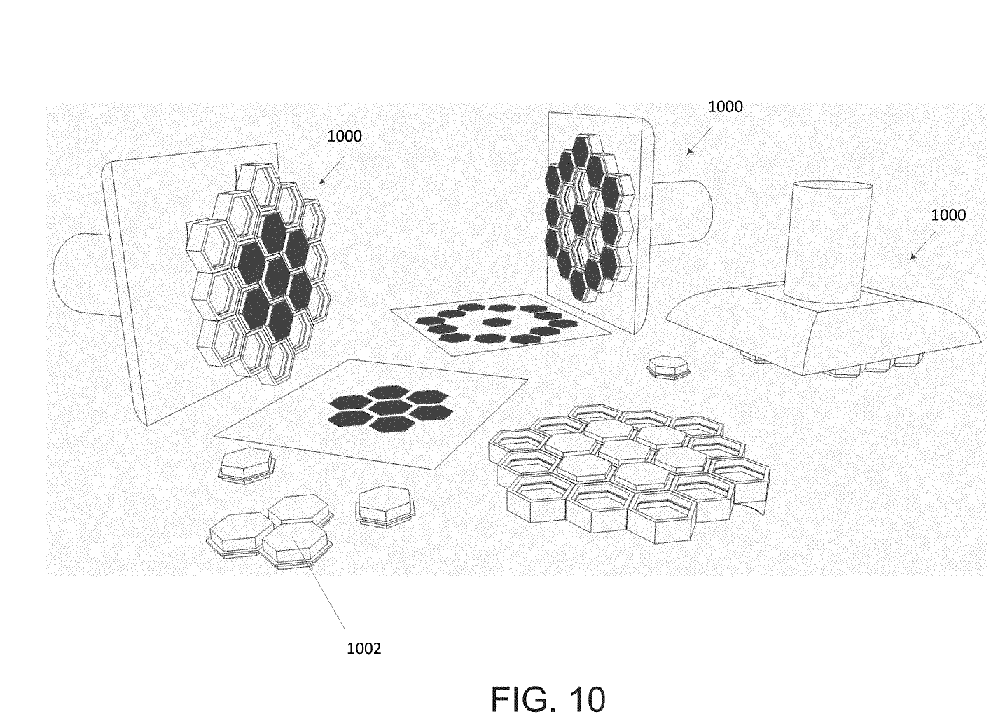

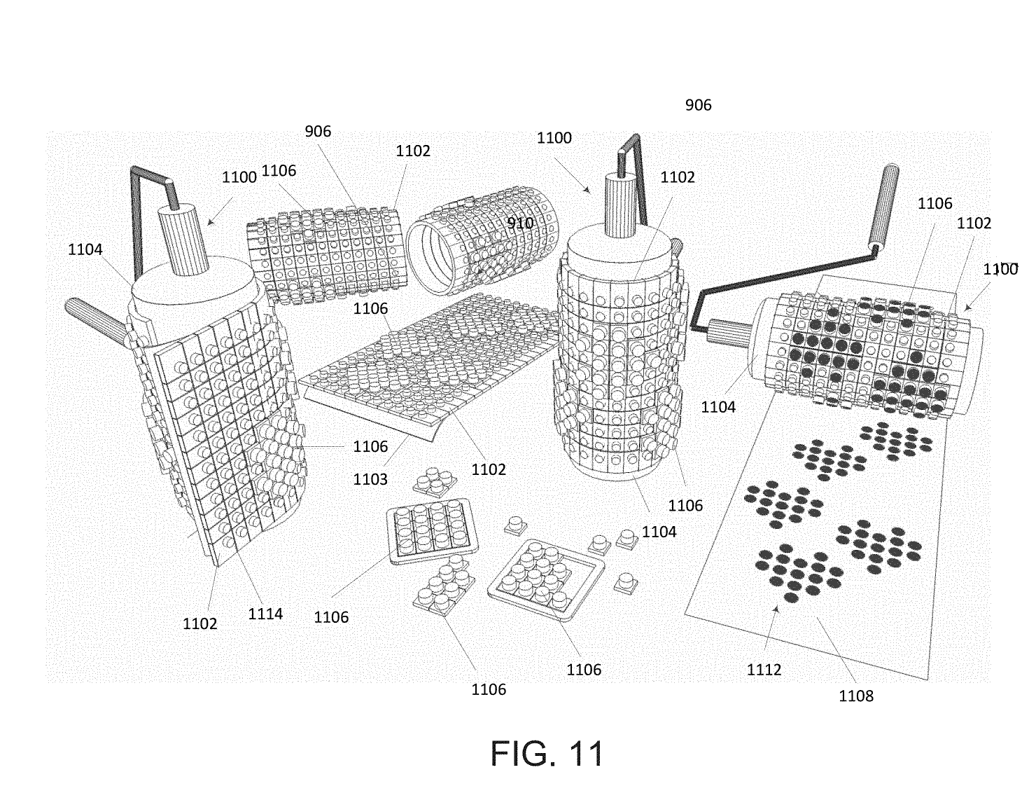

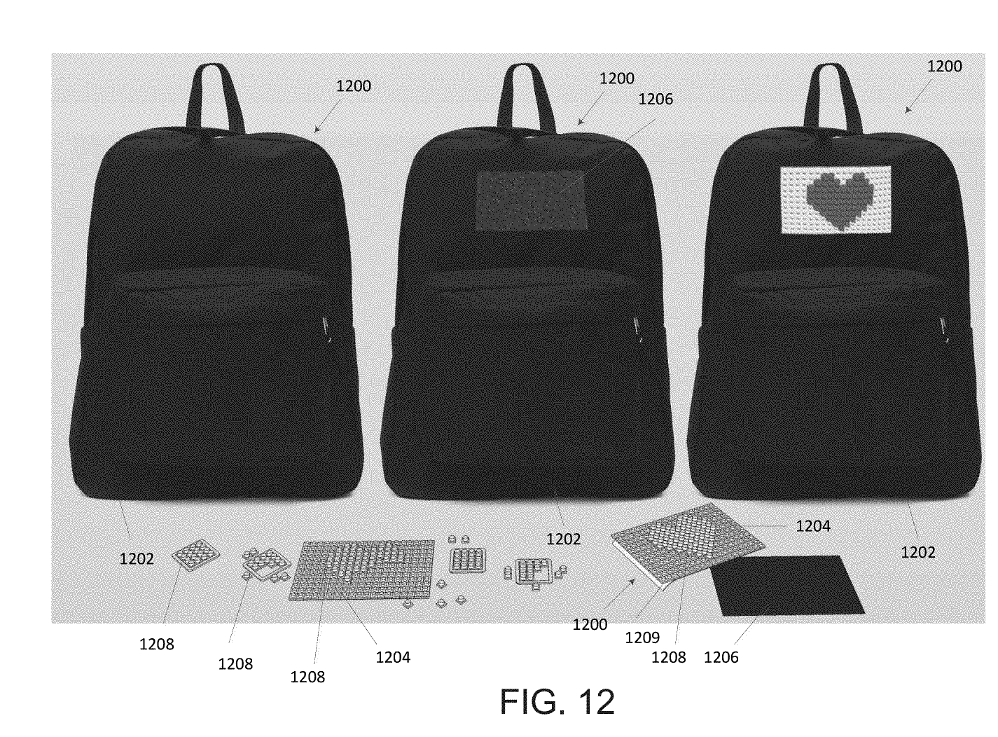

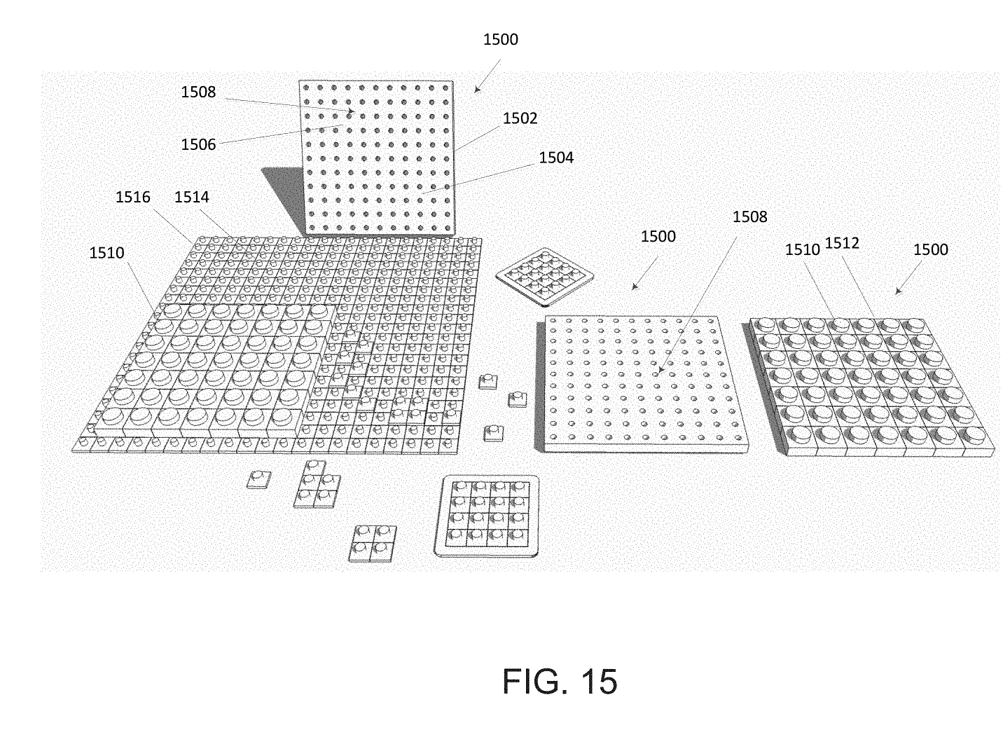

The following figures and corresponding descriptions provide context for the many applications and implementations of various embodiments of the disclosure. FIGS. 2-4 illustrate an example puzzle kit. FIG. 5 illustrates an example implementation for another puzzle kit. FIGS. 6-8 illustrate an example drinking containers. FIGS. 9-10 illustrate example printing stamps. FIG. 11 illustrates an example roller printing stamp. FIGS. 12-14 illustrate example patches, in particular for a bag, hat, and jacket. FIG. 15 illustrates an example conversion kit for use with third-party vendor building blocks or toys. The consumer products and toys described in the disclosure are merely examples, and one will recognize the applicability of various embodiments of the disclosure to any number of other consumer products, toys, and objects.

FIG. 2 illustrates a perspective view of an example puzzle kit including 5 pieces with respective pixel layers, substrates, and adhesive layers, in accordance with example embodiments of the disclosure. In the embodiment shown, the puzzle kit 200 can include five different sized pieces 202, 204, 206, 208, 210. In other embodiments, any number of different and/or similar sized pieces can exist. In any instance, the puzzle kit 200 can be assembled and re-assembled to form any number of shapes. The 5 pieces are uniquely designed to be assembled and re-assembled in any number of desired shapes. In particular, the 5 pieces are uniquely designed such that some or all of the pieces can be used to assemble and re-assemble in a variety of rectangular-shape and/or square shapes. One will recognize that each of the 5 pieces is scalable, and when all 5 pieces are increased proportionally in size, all of the pieces can be used to assemble and re-assemble in a variety of rectangular-shape and/or square shapes.

In certain embodiments of the disclosure, a puzzle kit, such as 200, can be used with predefined designs printed on an upper surface of an assembled puzzle kit, or designs can be printed as needed on the upper surface of an assembled puzzle kit.

In the embodiment shown in FIG. 2, piece 202 can be an elongated T-shaped piece with a 4×19 pixel rectangular portion 212 and a 3×3 pixel square portion 214. The square portion 214 is positioned adjacent the rectangular portion 212, and a lateral edge 216 of the square portion 214 is centered along a lateral edge 218 of the rectangular portion 212.

Next, piece 204 can be a cross-shaped piece with an 8×11 rectangular portion 220 and two 3×3 square shaped portions 222, 224. Each of the square portions 222, 224 is positioned adjacent the rectangular portion 220, and a lateral edge 226, 228 of each square portion 222, 224 is centered along a respective lateral edge 230, 232 of the rectangular portion 220.

Next, piece 206 can be an elongated cross-shaped piece with a 4×19 pixel rectangular portion 234 and two 3×3 pixel square portions 236, 238. Each of the square portions 236, 238 is positioned adjacent the rectangular portion 234, and a lateral edge 240, 242 of each square portion 236, 238 is centered along a respective lateral edge 244, 246 of the rectangular portion 234.

Further, piece 208 can be a T-shaped piece with a 4×11 pixel rectangular portion 248 and a 3×3 pixel square portion 250. The square portion 250 is positioned adjacent the rectangular portion 248, and a lateral edge 252 of the square portion 250 is centered along a lateral edge 254 of the rectangular portion 248.

Moreover, piece 210 can be a X-shaped piece with a central 5×5 square portion 256 and 4×4 square portions 258, 260, 262, 264, with each of the square portions 258, 260, 262, 264 sharing a respective common corner pixel 266, 268, 270, 272 with the square portion 256. A respective 3×3 pixel sized square open area 274, 276, 278, 280 spans between each adjacent square portion 258, 260, 262, 264.

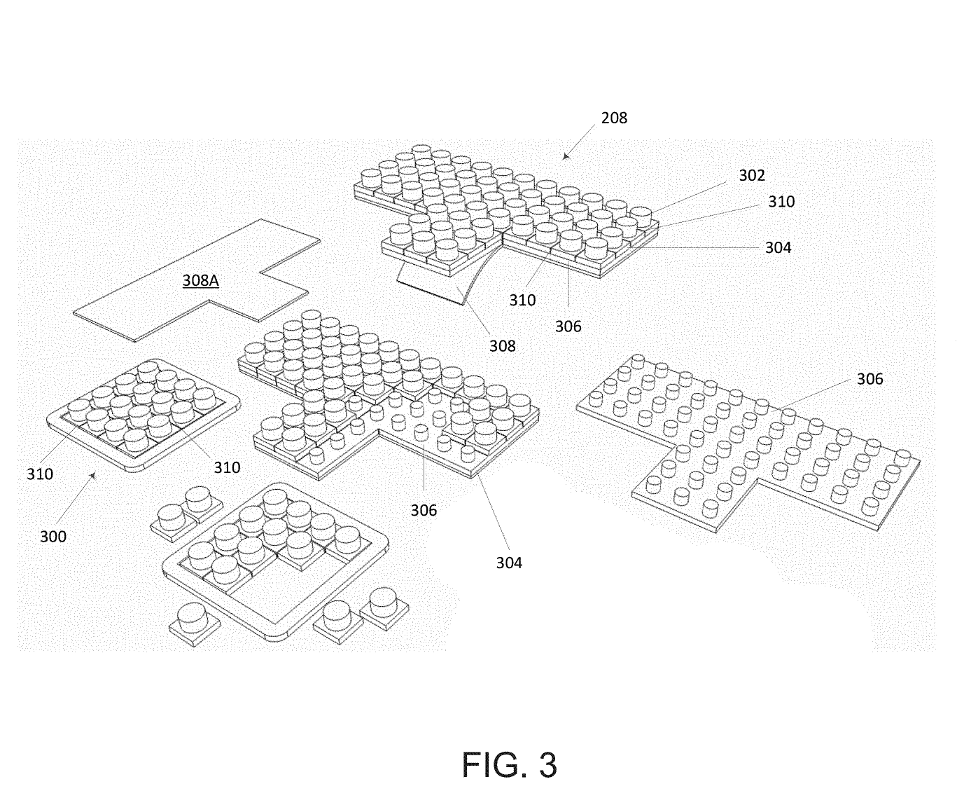

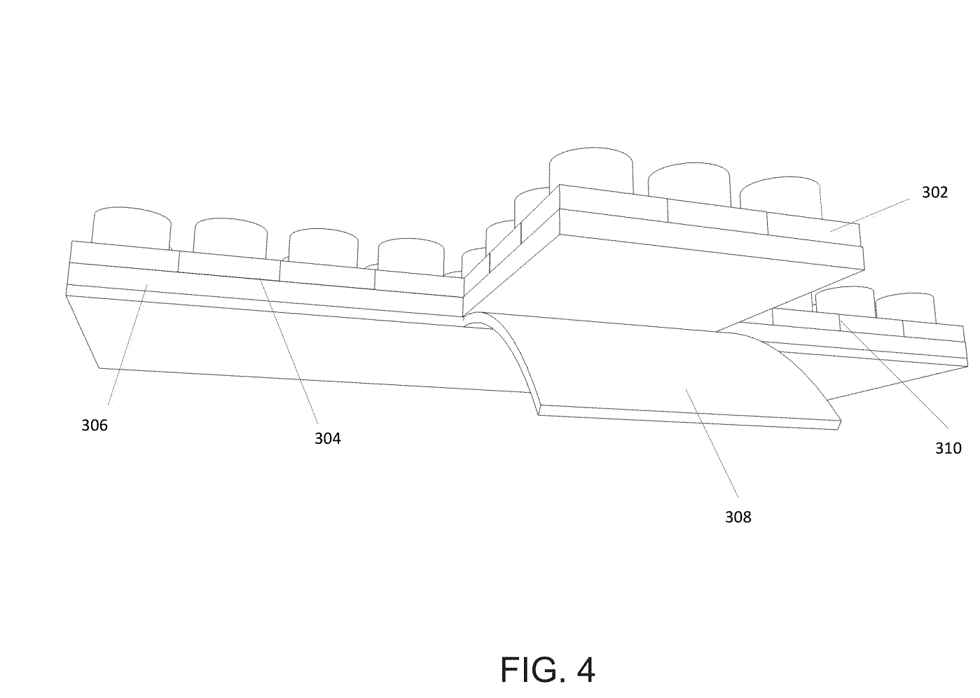

Each of the 5 pieces 202, 204, 206, 208, 210 of the puzzle kit 200 can include respective pixel layers 282, substrates 284, and adhesive layers 286 in accordance with example embodiments of the disclosure. The pixel layers 282, substrates 284, and adhesive layers 286 can be seen in greater detail in FIGS. 3 and 4. As seen in FIG. 2, any number and any configuration of pixels in each pixel layer, such as 288A, 288B, 288C, 288D, can be detached from each other and mounted to a respective substrate 284 of the pieces 202, 204, 206, 208, 210 of the puzzle kit 200. For example, the 4×4 pixel square-shape unit of 288A can be a commonly utilized unit for a pixel layer. Each pixel, similar to 288C, of the 4×4 pixel square-shape unit of 288A can be separated from the unit 288A, as can be seen in the respective unit 288B. The pixel layers 282 shown in FIG. 2 can include any number of elevated shapes, such as cylindrical, elongated cylindrical, rounded, square, or otherwise elevated protrusions that correspondingly fit onto an upper portion of a substrate 284. A respective adhesive 286 on the lower surface of the substrate 284 can connect the lower surface of a respective substrate 284 to an upper portion of a respective backing layer, such as described in FIG. 3. In certain embodiments, a respective adhesive on a lower surface of the pixel layers 282 can connect the lower surface of a respective pixel layer 282 to an upper portion of a respective substrate 284.

FIG. 3 illustrates a perspective detail view of piece 208 shown in FIG. 2 with an adhesive layer, and an adjacent example pixel layer 300, both according to example embodiments of the disclosure. Piece 208 shown in FIG. 3 includes a pixel layer 302, a pixel layer adhesive 304 on a lower portion of the pixel layer 302, a substrate 306, and a substrate adhesive 308 on a lower portion of the substrate 306. In certain embodiments, the piece 208 may be mounted to a backing layer 308A, which may or may not be removable. The backing layer 308A can include, but is not limited to, a magnetic sheet, cardboard stock, plastic, acrylic, wood, metal sheet, Eva foam, etc. In certain embodiments, the backing layer 308A may be mounted to the lower portion of the substrate 306 with an adhesive, such as 308, or other suitable means. Perforations 310 in the pixel layer 302 and/or substrate 306 can be formed or otherwise molded into the pixel layer 302 as needed to allow the pixel layer 302 and/or the substrate 306 to be pulled apart (for example, manually pulled apart). Alternatively, the pixel layer 302 and/or the substrate 306 can be cut into a predetermined shape by a scissor or a blade. Moreover, the pixel layer 302 and/or the substrate 306 can include perforations 310 to facilitate the separability of a relatively larger pixel layer and/or substrate into one or more relatively smaller constituent pixel layers and/or substrates. One will recognize that the shapes and sizes of the pixel layer 302 and corresponding substrate 306 can be any number of configurations including, but not limited to, squares, strips, rectangles, circles, ovals, triangular-shapes, geometric shapes, polygonal shapes, etc.

FIG. 4 illustrates a lower perspective detail view of piece 208 shown in FIGS. 2 and 3, according to example embodiments of the disclosure. Piece 208 shown in FIG. 4 includes a pixel layer 302, a pixel layer adhesive 304 on a lower portion of the pixel layer 302, a substrate 306, a substrate adhesive 308 on a lower portion of the substrate 306, and perforations 310 in the pixel layer 302 and/or substrate 306. One will recognize that the shapes and sizes of the pixel layer 302 and corresponding substrate 306 can be any number of configurations including, but not limited to, squares, strips, rectangles, circles, ovals, triangular-shapes, geometric shapes, polygonal shapes, etc.

FIG. 5 illustrates an upper perspective view of an example configuration for various pieces for a puzzle kit including respective pixel layers, substrates, and adhesive layers, in accordance with example embodiments of the disclosure. In the embodiment of FIG. 5, a puzzle piece for a puzzle kit can be formed from a hexagonal, geometric or other polygonal shape. Here, multiple hexagonal-shaped pixels 500 can be used to form a puzzle piece, which in turn can be assembled and re-assembled into a puzzle, similar to the puzzle pieces and puzzle in FIGS. 2-4. Each hexagonal-shaped pixel 500 can include a pixel layer 502, an optional pixel layer adhesive 504 on a lower portion of the pixel layer 502, a substrate 506, a substrate adhesive 508 on a lower portion of the substrate 506, and perforations 510 in the pixel layer 502 and/or substrate 506. One will recognize that the shapes and sizes of the pixel layer 502 and corresponding substrate 506 can be any number of configurations including, but not limited to, square-shaped, strip-shaped, rectangular-shaped, circular-shaped, oval-shaped, triangular-shaped, geometric-shaped, polygonal-shaped, etc.

FIG. 6 illustrates an example drinking bottle 600, in accordance with example embodiments of the disclosure. In this embodiment, a cylindrically-shaped substrate 602 can be mounted to or otherwise molded to or into an outer surface of a central core or container 606. An associated lid 604 can be mounted to an upper end of the cylindrically-shaped substrate 602, central core and/or container. The cylindrically-shaped substrate 602 can be concentrically inserted within a relatively larger transparent cup-type container 608, wherein the relative positions of the substrate 602 within the cup-type container 608 can be fixed by a connecting device or adhesive.

In some embodiments, the cylindrically-shaped substrate 602 can include a substrate adhesive on a lower portion of the substrate 602, wherein the adhesive mounts the substrate 602 to an outer surface of a central cylindrically-shaped core or container 606. Alternatively, the substrate 602 can be molded into a cylindrically-shaped core or container 606. In another aspect, the substrate 602 can be cut, separated, or otherwise formed as needed into one or more pieces that can be mounted to an outer surface of a central cylindrically-shaped core or container 606. Perforations 612 can be formed in the substrate 602 and/or pixel layer 610 as needed to facilitate cutting, separation, and/or forming. In any instance, the cylindrically-shaped substrate 602 can include any number of elevated shapes, such as cylindrical, elongated cylindrical, rounded, square, or otherwise elevated protrusions.

The example drinking bottle 600 can also include one or more pixel layers 610, which can be separated as needed and mounted to an outer surface of the substrate 602. Each of the pixel layers 610 can include a pixel layer adhesive on a lower portion of the respective pixel layer 610. In any instance, the cylindrically-shaped substrate 602 can receive the one or more pixel layers 610, which can be mounted to the respective elevated shapes and/or protrusions associated with the substrate 602.

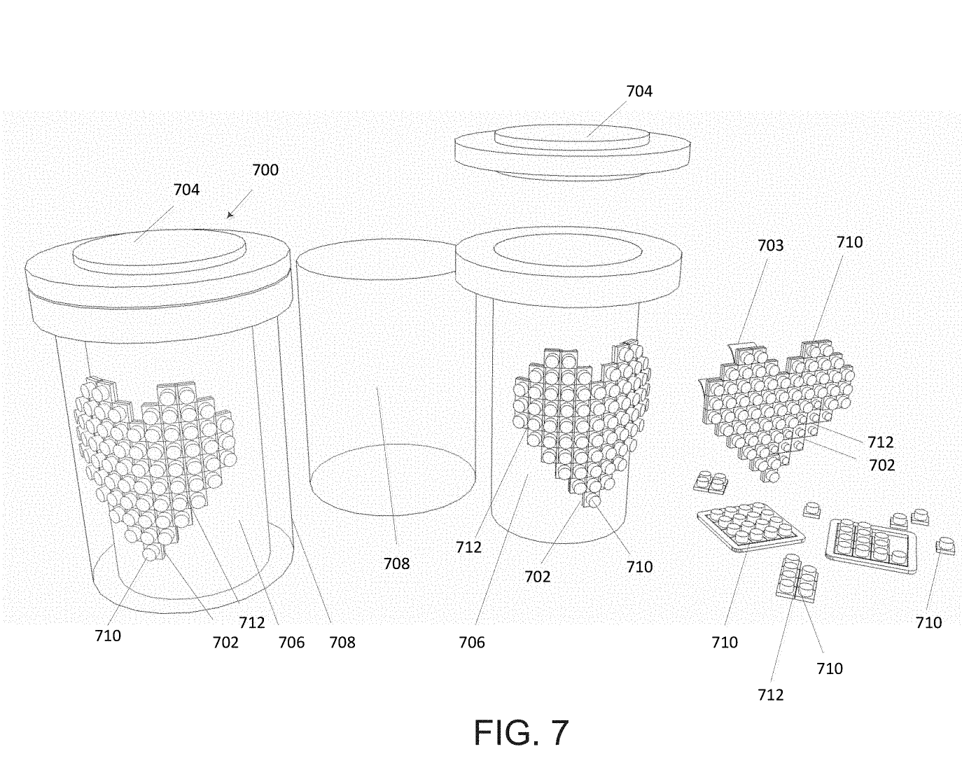

FIG. 7 illustrates an example drinking bottle 700, in accordance with example embodiments of the disclosure. Similar to the embodiment in FIG. 6, in this embodiment, a predefined or otherwise shaped substrate 702 can be mounted to or otherwise molded to or into an outer surface of a central core or container 706. An associated lid 704 can be mounted to an upper end of the central core and/or container 706. The substrate 702 mounted to the central core and/or container 706 can be concentrically inserted within a relatively larger transparent cup-type container 708, wherein the relative positions of the central core and/or container 706 within the cup-type container 708 can be fixed by a connecting device or adhesive.

In some embodiments, the substrate 702 can include a substrate adhesive 703 on a lower portion of the substrate 702, wherein the adhesive mounts the substrate 702 to an outer surface of a central cylindrically-shaped core or container 706. Alternatively, the substrate 702 can be molded into a cylindrically-shaped core or container 706. In another aspect, the substrate 702 can be cut, separated, or otherwise formed as needed into one or more pieces that can be mounted to an outer surface of a central cylindrically-shaped core or container 706. Perforations 712 can be formed in the substrate 702 and/or pixel layer 710 as needed to facilitate cutting, separation, and/or forming. In any instance, the cylindrically-shaped substrate 702 can include any number of elevated shapes, such as cylindrical, elongated cylindrical, rounded, square, or otherwise elevated protrusions.

The example drinking bottle 700 can also include one or more pixel layers 710, which can be separated as needed and mounted to an outer surface of the substrate 702. Each of the pixel layers 710 can include a pixel layer adhesive on a lower portion of the respective pixel layer 710. In any instance, the substrate 702 can receive the one or more pixel layers 710, which can be mounted to the respective elevated shapes and/or protrusions associated with the substrate 702.

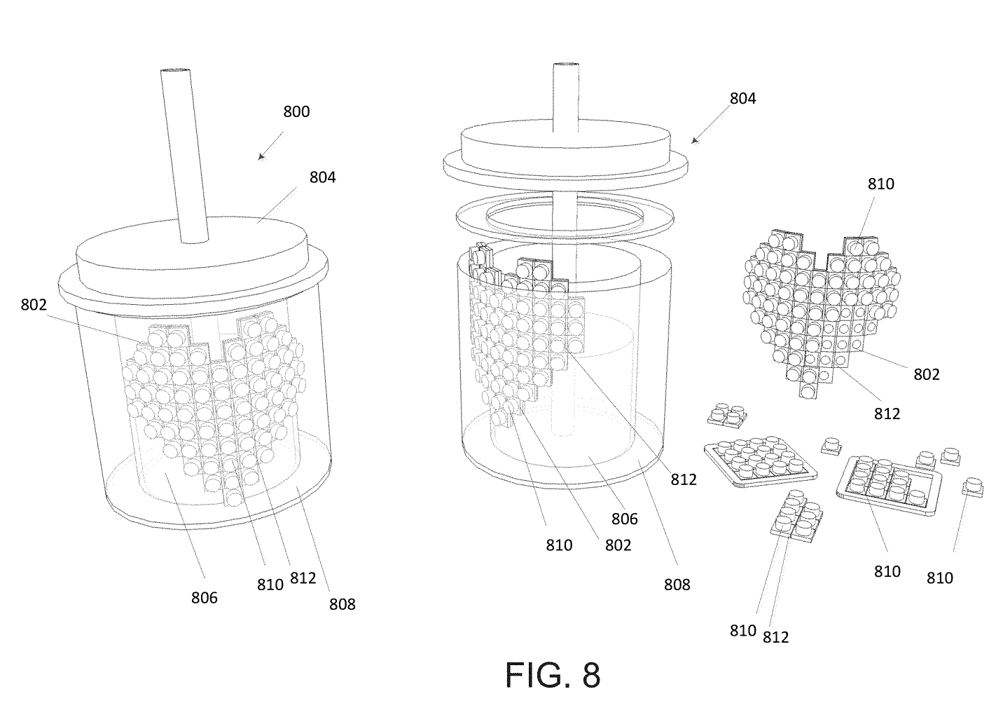

FIG. 8 illustrates an example drinking cup 800, in accordance with example embodiments of the disclosure. Similar to the embodiments in FIGS. 6 and 7, in this embodiment, a predefined or otherwise shaped substrate 802 can be mounted to or otherwise molded to or into an outer surface of a central core or container 806. An associated lid and drinking straw assembly 804 can be mounted to an upper end of the central core and/or container 806. The substrate 802 mounted to the central core and/or container 806 can be concentrically inserted within a relatively larger transparent cup-type container 808, wherein the relative positions of the central core and/or container 806 within the cup-type container 808 can be fixed by a connecting device or adhesive.

In some embodiments, the substrate 802 can include a substrate adhesive on a lower portion of the substrate 802, wherein the adhesive mounts the substrate 802 to an outer surface of a central cylindrically-shaped core or container 806. Alternatively, the substrate 802 can be molded into a cylindrically-shaped core or container 806. In another aspect, the substrate 802 can be cut, separated, or otherwise formed as needed into one or more pieces that can be mounted to an outer surface of a central cylindrically-shaped core or container 806. Perforations 812 can be formed in the substrate 802 and/or pixel layer 810 as needed to facilitate cutting, separation, and/or forming. In any instance, the cylindrically-shaped substrate 802 can include any number of elevated shapes, such as cylindrical, elongated cylindrical, rounded, square, or otherwise elevated protrusions.

The example drinking cup 800 can also include one or more pixel layers 810, which can be separated as needed and mounted to an outer surface of the substrate 802. Each of the pixel layers 810 can include a pixel layer adhesive on a lower portion of the respective pixel layer 810. In any instance, the substrate 802 can receive the one or more pixel layers 810, which can be mounted to the respective elevated shapes and/or protrusions associated with the substrate 802.

FIG. 9 illustrates an example printing stamp 900, in accordance with example embodiments of the disclosure. In this embodiment, a predefined or otherwise shaped substrate 902 can be mounted to or otherwise molded to or into an outer surface of a stamping device 904. The substrate 902 mounted to the stamping device 904 can be adorned with or otherwise decorated with one or more pixel layers 906. In use, the stamping device 904 can be manipulated to either depress the pixel layers 906 into ink or onto a surface of an ink pad. Alternatively, the pixel layers 906 may include a respective ink reservoir or ink supply. In any instance, when the pixel layers 906 are pressed onto a clean surface 908, ink 910 from the pixel layers 906 can be transferred from the pixel layers 906 to the surface 908 leaving a printed design 912 on the surface.

In some embodiments, the substrate 902 can include a substrate adhesive on a lower portion of the substrate 902, wherein the adhesive mounts the substrate 902 to an outer surface of the stamping device 904. Alternatively, the substrate 902 can be molded into an outer surface of the stamping device 904. In another aspect, the substrate 902 can be cut, separated, or otherwise formed as needed into one or more pieces that can be mounted to an outer surface of an outer surface of the stamping device 904. Perforations 914 can be formed in the substrate 902 and/or pixel layer 906 as needed to facilitate cutting, separation, and/or forming. In any instance, the substrate 902 can include any number of elevated shapes, such as cylindrical, elongated cylindrical, rounded, square, or otherwise elevated protrusions.

The example printing stamp 900 can also include one or more pixel layers 906, which can be separated as needed and mounted to an outer surface of the substrate 902. Each of the pixel layers 906 can include a pixel layer adhesive on a lower portion of the respective pixel layer 906. In any instance, the substrate 902 can receive the one or more pixel layers 910, which can be mounted to the respective elevated shapes and/or protrusions associated with the substrate 902.

FIG. 10 illustrates another example printing stamp, in accordance with example embodiments of the disclosure. The printing stamp 1000 shown uses hexagonal-shaped pixels 1002, similar to 500 in FIG. 5, with a configuration similar to the printing stamp 900 in FIG.

9.

FIG. 11 illustrates an example roller printing stamp 1100, in accordance with example embodiments of the disclosure. In this embodiment, a predefined or otherwise shaped substrate 1102 can be mounted to or otherwise molded to or into an outer surface of a roller printing stamp device 1104. The substrate 1102 mounted to the roller printing stamp device 1104 can be adorned with or otherwise decorated with one or more pixel layers 1106. In use, the roller printing stamp 1104 can be manipulated to either depress the pixel layers 1106 into ink or onto a surface of an ink pad. Alternatively, the pixel layers 1106 may include a respective ink reservoir or ink supply. In any instance, when the pixel layers 1106 are pressed onto a clean surface 1108, ink 1110 from the pixel layers 1106 can be transferred from the pixel layers 1106 to the surface 1108 leaving a printed design 1112 on the surface.

In some embodiments, the substrate 1102 can include a substrate adhesive 1103 on a lower portion of the substrate 1102, wherein the adhesive mounts the substrate 1102 to an outer surface of the roller printing stamp device 1104. Alternatively, the substrate 1102 can be molded into an outer surface of the roller printing stamp device 1104. In another aspect, the substrate 1102 can be cut, separated, or otherwise formed as needed into one or more pieces that can be mounted to an outer surface of the roller printing stamp device 1104. Perforations 1114 can be formed in the substrate 1102 and/or pixel layer 1106 as needed to facilitate cutting, separation, and/or forming. In any instance, the substrate 1102 can include any number of elevated shapes, such as cylindrical, elongated cylindrical, rounded, square, or otherwise elevated protrusions.

The example roller printing stamp 1100 can also include one or more pixel layers 1106, which can be separated as needed and mounted to an outer surface of the substrate 1102. Each of the pixel layers 1106 can include a pixel layer adhesive on a lower portion of the respective pixel layer 1106. In any instance, the substrate 1102 can receive the one or more pixel layers 1110, which can be mounted to the respective elevated shapes and/or protrusions associated with the substrate 1102.

FIG. 12 illustrates an example patch 1200 for a bag 1202, in accordance with example embodiments of the disclosure. In this embodiment, a predefined or otherwise shaped substrate 1204 can be mounted to or otherwise molded to or into an outer surface of the bag 1202 and/or associated patch mount 1206. The substrate 1204 mounted to the outer surface of a bag 1202 and/or associated patch mount 1206 can be adorned with or otherwise decorated with one or more pixel layers 1208.

In some embodiments, the substrate 1204 can include a substrate adhesive 1209 on a lower portion of the substrate 1202, wherein the adhesive mounts the substrate 1202 to an outer surface of the bag 1202 and/or associated patch mount 1206. Alternatively, the substrate 1202 can be mounted to the bag 1202 and/or patch mount 1206 using Velcro or similar fastening mechanism. In another aspect, the substrate 1202 can be cut, separated, or otherwise formed as needed into one or more pieces that can be mounted to an outer surface of the bag 1202 and/or associated patch mount 1206. Perforations can be formed in the substrate 1204 and/or pixel layer 1208 as needed to facilitate cutting, separation, and/or forming. In any instance, the substrate 1204 can include any number of elevated shapes, such as cylindrical, elongated cylindrical, rounded, square, or otherwise elevated protrusions.

The example patch 1200 for a bag 1202 can also include one or more pixel layers 1208, which can be separated as needed and mounted to an outer surface of the substrate 1204. Each of the pixel layers 1208 can include a pixel layer adhesive on a lower portion of the respective pixel layer 1208. In any instance, the substrate 1204 can receive the one or more pixel layers 1208, which can be mounted to the respective elevated shapes and/or protrusions associated with the substrate 1204.

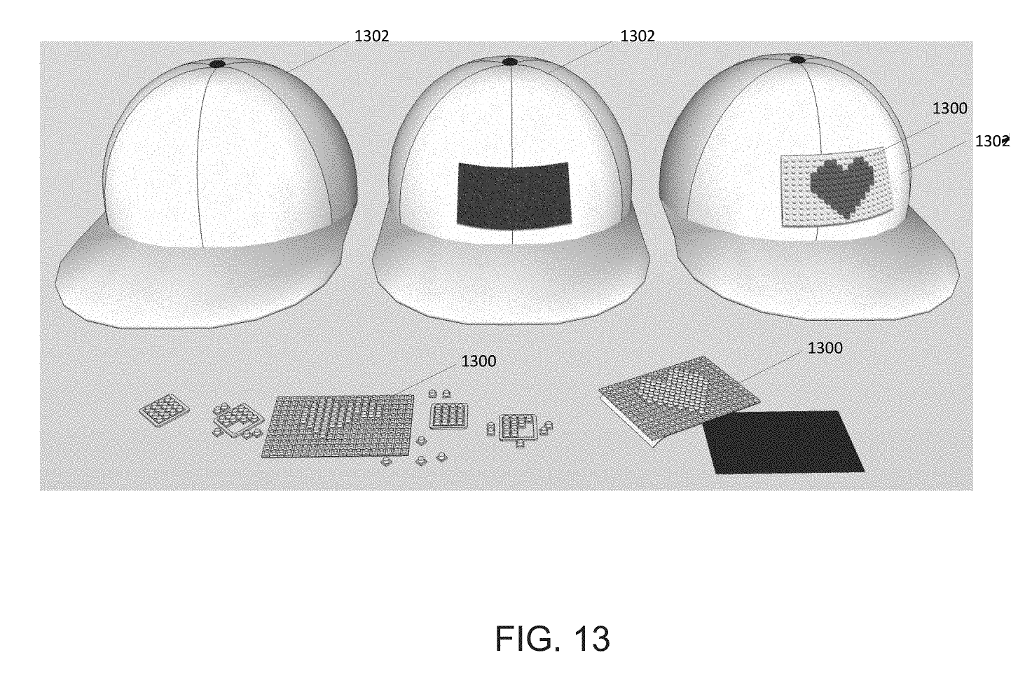

FIG. 13 illustrates an example patch 1300 for a hat 1302, in accordance with example embodiments of the disclosure. Similar to the embodiment in FIG. 12, a patch 1300 for a hat 1302 can be provided. In the embodiment shown in FIG. 13, a predefined or otherwise shaped substrate, or patch 1300, can be mounted to or otherwise molded to or into an outer surface of the hat 1302 and/or associated patch mount. For example, the substrate, or patch 1300, can be a circular-shape, oval-shape, geometric shape, or other polygonal shape. The substrate or patch 1300 mounted to the outer surface of the hat 1302 and/or associated patch mount can be adorned with or otherwise decorated with one or more pixel layers.

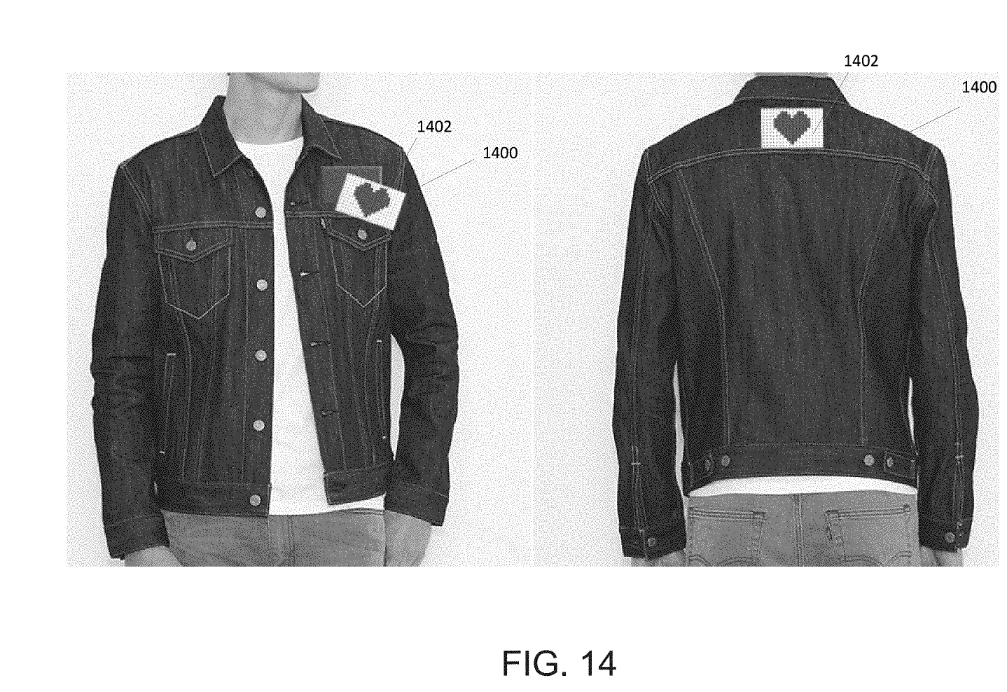

FIG. 14 illustrates an example patch for a jacket in accordance with example embodiments of the disclosure. Similar to the embodiments in FIGS. 11 and 12, a patch 1400 for a jacket 1402 can be provided. In the embodiment shown in FIG. 14, a predefined or otherwise shaped substrate, or patch 1400, can be mounted to or otherwise molded to or into an outer surface of the jacket 1402 and/or associated patch mount 1406. For example, the substrate, or patch 1400, can be a circular-shape, oval-shape, geometric shape, or other polygonal shape. The substrate or patch 1400 mounted to the outer surface of the jacket 1402 and/or associated patch mount can be adorned with or otherwise decorated with one or more pixel layers.

FIG. 15 illustrates an example converter device 1500 in accordance with example embodiments of the disclosure. The converter device 1500 can include a substrate 1502 that has an adhesive layer 1504 on a lower surface 1506 of the converter device 1500, a set of cavities 1508 on the lower surface 1506 of the converter device 1500, and a set of elevated surfaces or protrusions 1510 on an upper surface 1512 of the converter device 1500. For example, the surfaces or protrusions 1510 can be circular-shaped, oval-shaped, polygonal shaped, or any other geometrically-shaped feature. The set of elevated surfaces or protrusions 1510 is operable to receive corresponding shapes, such as cavities, on a lower surface of a pixel layer or a third-party toy building block. For example, the corresponding shapes, such as cavities, can be circular-shaped, oval-shaped, polygonal shaped, or any other geometrically-shaped feature. The set of elevated surfaces or protrusions 1510 of the upper surface 1512 of the converter device 1500 can be configured with any configuration of surfaces or protrusions to be suitable to mate with and/or connect with corresponding shapes, such as cavities, on a lower surface of a pixel layer or a third-party toy building block.

The converter device 1500 shown in FIG. 15 is merely illustrated by way of example, and other configurations can be implemented. In the example shown, the lower surface 1506 of the converter device 1500 can be mounted to relatively small elevated surfaces or protrusions 1514 of an underlying substrate 1516. The upper surface 1512 of the converter device 1500 can receive for mounting relatively larger shapes, such as cavities, on a lower surface of a pixel layer or a third-party toy building block. In this manner, the converter device 1500 can facilitate use of an underlying substrate 1516 configured for use with a pixel layer or a third-party toy building block of one type provided by one manufacturer with a different pixel layer or a third-party toy building block of another type provided by the same or different manufacturer.

Various features, aspects, and embodiments have been described herein. The features, aspects, and embodiments are susceptible to combination with one another as well as to variation and modification, as will be understood by those having skill in the art. The present disclosure should, therefore, be considered to encompass such combinations, variations, and modifications.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Other modifications, variations, and alternatives are also possible. Accordingly, the claims are intended to cover all such equivalents.

While the disclosure includes various embodiments, including at least a best mode, it is to be understood that many alternatives, modifications, and variations will be apparent to those skilled in the art in light of the foregoing description. Accordingly, the disclosure is intended to embrace all such alternatives, modifications, and variations, which fall within the scope of the included claims. All matters disclosed herein or shown in the accompanying drawings are to be interpreted in an illustrative and non-limiting sense.

This written description uses examples to disclose certain embodiments of the disclosure, including the best mode, and also to enable any person skilled in the art to practice certain embodiments of the disclosure, including making and using any apparatuses, devices, or systems and performing any incorporated methods and processes. The patentable scope of certain embodiments of the disclosure is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

The claimed disclosure is:

1. An apparatus comprising:
a pixel layer; and
a substrate, the substrate comprising a flexible and separable unit;
wherein the substrate comprises one or more protrusions and the pixel layer comprises one or more cavities;
wherein the pixel layer is attached to the substrate at least in part by a mechanical mating of the one or more cavities of the pixel layer with the one or more protrusions of the substrate; and
wherein the substrate further comprises an adhesive layer on at least one face of the substrate.

2. The apparatus of claim 1, wherein the adhesive layer further comprises a washable layer.

3. The apparatus of claim 1, wherein the adhesive layer further comprises one or more of a synthetic adhesive, a pressure-sensitive adhesive (PSA), a multi-component adhesive, a contact adhesive, a solvent-based adhesive, or a polymer dispersion adhesive.

4. The apparatus of claim 1, wherein the substrate further comprises one or more perforations to facilitate the separability of the substrate into one or more smaller constituent substrates.

5. The apparatus of claim 1, wherein the adhesive layer further comprises a removable backing layer that at least partially protects the adhesive layer from at least one environmental factor.

6. The apparatus of claim 5, wherein the removable backing layer comprises a plastic film.

7. The apparatus of claim 1, wherein the adhesive layer adheres to a surface of a predetermined type.

8. The apparatus of claim 1, wherein the pixel layer further comprises an adhesive layer.

9. The apparatus of claim 8, wherein the adhesive layer further comprises a washable layer.

10. The apparatus of claim 8, wherein the adhesive layer further comprises one or more of a synthetic adhesive, a pressure-sensitive adhesive (PSA), a multi-component adhesive, a contact adhesive, a solvent-based adhesive, or a polymer dispersion adhesive.

11. A method for decorating a surface, the method comprising:
providing a substrate to mount a pixel layer at least in part by a mechanical mating of one or more cavities of the pixel layer with one or more protrusions of the substrate, wherein the substrate has an adhesive layer on at least one face of the substrate; and
attaching, using the adhesive layer, the substrate having the pixel layer to a first surface.

12. The method of claim 11, wherein the pixel layer further comprises a flexible and separable unit.

13. The method of claim 11, wherein the adhesive layer further comprises a washable layer.

14. The method of claim 11, wherein the adhesive layer further comprises one or more of a synthetic adhesive, a pressure-sensitive adhesive (PSA), a multi-component adhesive, a contact adhesive, a solvent-based adhesive, or a polymer dispersion adhesive.

15. The method of claim 11, wherein the substrate further comprises one or more perforations to facilitate the separability of the substrate into one or more smaller constituent substrates.

16. The method of claim 11, wherein the adhesive layer further comprises a removable backing layer that at least partially protects the adhesive layer from at least one environmental factor.

17. The method of claim 16, wherein the removable backing layer further comprises a plastic film.

18. The method of claim 11, wherein the method further comprises adhering the adhesive layer to a surface of a predetermined type.

19. The method of claim 11, wherein the pixel layer further comprises an adhesive layer, and the adhesive layer further comprises a washable layer.

20. The method of claim 19, wherein the adhesive layer further comprises one or more of a synthetic adhesive, a pressure-sensitive adhesive (PSA), a multi-component adhesive, a contact adhesive, a solvent-based adhesive, or a polymer dispersion adhesive.
